(19) United States
(12) Patent Application Publication
(10) Pub. No.: US 2023/0413072 A1
(43) Pub. Date: Dec. 21, 2023

(54) RADIO NETWORK PERFORMANCE OPTIMIZATION SYSTEM AND METHOD

(71) Applicant: Shomenath Roy Chowdhury, New Delhi (IN)

(72) Inventor: Shomenath Roy Chowdhury, New Delhi (IN)

(21) Appl. No.: 18/250,834

(22) PCT Filed: Dec. 30, 2020
(86) PCT No.: PCT/IN2020/051069

§ 371 Date: Apr. 27, 2023

(30) Foreign Application Priority Data
Oct. 31, 2020 (IN) 202011047642

(51) Int. Cl. H04W 24/02; H04W 24/08; H04W 24/10

(52) U.S. Cl. CPC H04W 24/02; H04W 24/10; H04W 24/08

(57) ABSTRACT

Described herein is a radio network performance optimization system and method. The present invention is configured to improve network performance field processes, network performance solution, network performance data analytics as well as management information. The system includes a field process automation module, a network performance data analytics module and a management module. The field process automation module is configured to automate field processes in a drive testing procedure. The network performance data analytics module is configured to perform centralized automated analytics on the data retrieved from the field process automation module. The management module is configured to manage the field process automation module and the network performance data analytics module.

### CROSS-REFERENCE TO RELATED APPLICATIONS

This application is a 35 U.S.C. § 371 National Stage Application of PCT/IN2020/051069, filed Dec. 30, 2020, which claims the benefit of priority to India Patent Application Serial No. 202011047642, filed on Oct. 31, 2020, the disclosures of which are incorporated herein by reference in their entirety.

### TECHNICAL FIELD

The present subject matter in general relates to facilitating transmission of high-quality signals to mobile phone users and in particularly relates to a system and method for radio network roll out and performance optimization by improving the drive testing procedures.

### BACKGROUND

Radio network roll out and performance evaluation is core in providing quality of experience to mobile subscribers. While drive testing is one critical step in this process, the effectiveness of this process has been reducing logarithmically. Conventional drive testing procedure is a highly manpower intensive process in which multiple teams from multiple vendors are required to work in different aspects by using different drive test solutions for the same task. This results in absolute non-standardization of the process and is a nightmare as far as collection and/or processing of data is concerned. Various processes in conventional systems, including field process, drive test solutions, centralized processes etc. do not exhibit any integrated approach and happen in silos. Non-integrated operations in silos lead to significant time inefficiencies, thereby resulting in the entire industry looking for alternatives to drive testing.

Typically, in a drive test process, multiple teams from multiple vendors are involved and employ different drive test solutions for the same task. The entire process is done manually or involves a large amount of human intervention, thereby being susceptible to human errors and data tampering. There is no standardization in the existing process for adapting multiple standards, hence are inefficient in data analysis, do not effectively extend acceptance timelines, and impact entire project economy. Moreover, the existing system and process does not provide real time visibility of complete set of KPI's/data, context sensitive drill down etc. This leads to inaccuracy in terms of on-field decision making, thereby resulting in rejection of the activities already performed, redrives to be conducted and delayed timelines. This makes the entire process ineffective and the key stakeholders look to explore alternatives. Rejection of activities, incorrect redrive decisions, unavailability of guided shortest path with close monitoring lead to an increased number of hours and/or distance required to be driven to complete the task. For example, with one operator with about 250 drive test, various teams conduct data collection on ground. If each team drives even one hour extra per day, it amounts to approximately 7500 km of extra drive every day considering an average of 30 km/hour drive. This leads to approximately 750 L of extra fuel consumption every day. At an average of Rs. 80 per liter, this incurs an additional cost of Rs. 60,000/-per day, and about Rs. 21.6 mn annually. Considering global drive testing, this number goes up exponentially with each passing test.

Globally, governments are driving for clean energy and reduction in fuel usage in an attempt to reduce pollution and carbon footprints. Conventional drive testing process does not involve any setup that can be considered as assisting in reduction of carbon footprint. Moreover, the needs of technology and telecom operators change frequently with time. Usually, telecom operators require 360° view of the network performance. However, the drive tests conducted in conventional systems are based only on network performance optimization, which is restricted to field drive test data alone. No solution in the art is capable of integrating field drive testing with additional data sources like crowdsourced data, OSS data etc.

One of the challenges in conventional process is to ensure that correct as well as due importance and attention are given by all key stakeholders to the process of drive testing. Over the years of inefficient operations, and stakeholders exploring other alternatives, conventional process is considered non-technical, non-effective and non-value adding. Since the conventional process involves field processes, centralized processes and solutions, people involved in all these are hugely different in their thought process, experience, and expectations. Not only are such people different, their views are entirely indifferent to problems faced by others involved in the process.

Moreover, every vendor involved in the process has their own file format, database, post-processing solution and so on. Even within the same solution provider, there is no universal and generic database and hence, working on Artificial Intelligence and Machine Learned for predictive analysis etc. is almost impossible.

Therefore, there is a well felt need for a system and method that overcomes the above and other related challenges and at the same time automates and brings insight into drive test data on a real time basis, besides building analytics insight into the same.

### SUMMARY

It is an object of the present subject matter to provide a common database and file format for drive testing procedure.

It is another object of the present subject matter to provide a hyper scalable database architecture that is configured to handle multi-vendor as well as multi-source data.

It is yet another object of the present subject matter to build adaption layers to ensure that vendor data coming from different file formats are converted to a common database format and data storage/structure is modified to meet needs and demands of big data analytics as well as Artificial Intelligence (AI)/Machine Learning (ML) driven root cause analysis and predictions.

It is yet another object of the present subject matter to substantially reduce human errors and human induced inefficiencies in drive testing procedures.

It is yet another object of the present subject matter to provide a system and a method for radio network performance optimization that can be easily adopted by almost all regions and countries with extreme ease, and user friendly Graphical user interface (GUI).

It is yet another object of the present subject matter to provide a user-friendly process and system that accounts for every minuscule detail of a field activity right from start till the end in a drive testing process.

It is yet another object of the present subject matter to generate and present accurate and real-time reports for each completed activity in a drive testing process.

The present invention is configured to improve network performance field processes, network performance solution, network performance data analytics as well as management information, thereby leading to significant savings in total cost of ownership while improving quality of drive testing procedure.

The subject matter relates to a radio network performance optimization system comprising a field process automation module configured to automate field processes in a drive testing procedure; a network performance data analytics module configured to perform centralized automated analytics on the data retrieved from the field process automation module; and a management module configured to provide manage the field process automation module and the network performance data analytics module.

In an embodiment of the present subject matter, the field process automation module further comprises a hardware check module, a license validation and setup module, a route determination module, a geofencing module, a vendor agnostic module and a data collection module.

In another embodiment of the present subject matter, the hardware check module is configured to evaluate all required components and raise an alarm even before a field team sets out for the activity in case any modification is required.

In yet another embodiment of the present subject matter, the license validation and setup module comprises a plurality of prebuilt scripts and is configured to check software versions, and to ensure that compatible settings are performed from central location.

In yet another embodiment of the present subject matter, the route determination module is configured to determine the shortest path or route to the starting point for drive testing and provides route MAP automation/centralization.

In yet another embodiment of the present subject matter, the geofencing module is configured to prevent the drive test team from diverting to an undesired location and starting to collect data before they should.

In yet another embodiment of the present subject matter, the vendor agnostic module is configured to standardize the field data collection process in a common database.

In yet another embodiment of the present subject matter, the data collection module is configured to automate the data collection by making a sequence of test cases, as well as to create and auto upload data per unit test case.

In yet another embodiment of the present subject matter, the network performance data analytics module comprises an integrated crowdsource data module, an automated analytics platform, and a network performance scoring module.

In yet another embodiment of the present subject matter, the integrated crowdsource data module is configured to provide real 360 degrees view of Geospatial Intelligence of network performance data with associated customer experience data.

In yet another embodiment of the present subject matter, the automated analytics platform is configured to provide context sensitive layer 3 (L3) message drill down with correlation for addressing the associated problems.

In yet another embodiment of the present subject matter, the network performance scoring module is configured to compare gold standard performance with current performance, thereby generating a rank of operators.

In yet another embodiment of the present subject matter, the system further comprises a network performance data repository to understand the trend of network performance.

In yet another embodiment of the present subject matter, the system employs Machine Learning (ML) and Artificial Intelligence (AI) driven approach with Geospatial intelligence driven algorithms to store data in the network performance data repository.

In yet another embodiment of the present subject matter, the system further comprises a big data architecture that is configured to quickly scan and capture data of interest.

The present subject matter also provides a radio network performance optimization method comprising automating field processes in a drive testing procedure; performing centralized automated analytics on the data retrieved from the automated field processes; and managing the field process automation module and the network performance data analytics module.

### BRIEF DESCRIPTION OF ACCOMPANYING DRAWINGS

The present invention, both as to its organization and manner of operation, together with further objects and advantages, may best be understood by reference to the following description, taken in connection with the accompanying drawings. These and other details of the present invention will be described in connection with the accompanying drawings, which are furnished only by way of illustration and not in limitation of the invention, and in which drawings:

FIG. 1 illustrates a block diagram of a radio network performance optimization system in accordance with a preferred embodiment of the present subject matter.

FIG. 2 illustrates a block diagram of the network performance data analytics module in accordance with a preferred embodiment of the present subject matter.

FIG. 3 depicts a block diagram of the network performance data analytics module in accordance with a preferred embodiment of the present subject matter

FIG. 4 illustrates an architecture of a radio network performance optimization system in accordance with one embodiment of the present subject matter.

FIG. 5 illustrates a flow chart of a site task allocation process in the radio network performance optimization system in accordance with one embodiment of the present subject matter.

FIG. 6 illustrates a flow chart depicting pre-checks to be performed before collection of data in the radio network performance optimization system in accordance with one embodiment of the present subject matter.

FIG. 7 illustrates a flow chart depicting data collection process in the radio network performance optimization system in accordance with one embodiment of the present subject matter.

FIG. 8 illustrates a flow chart depicting data processing in the radio network performance optimization system in accordance with one embodiment of the present subject matter.

FIG. 9 illustrates a flow chart depicting a 360-degree analysis of the radio network performance optimization system in accordance with one embodiment of the present subject matter.

### DETAILED DESCRIPTION

The following presents a detailed description of various embodiments of the present subject matter with reference to the accompanying drawings.

The embodiments of the present subject matter are described in detail with reference to the accompanying drawings. However, the present subject matter is not limited to these embodiments which are only provided to explain more clearly the present subject matter to a person skilled in the art of the present disclosure. In the accompanying drawings, like reference numerals are used to indicate like components.

The specification may refer to “an”, “one”, “different” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “attached” or “connected” or “coupled” or “mounted” to another element, it can be directly attached or connected or coupled to the other element or intervening elements may be present. As used herein, the term “and/or” includes any and all combinations and arrangements of one or more of the associated listed items.

The figures depict a simplified structure only showing some elements and functional entities, all being logical units whose implementation may differ from what is shown.

The present invention provides a system and method which is aimed at optimizing the entire drive test procedure globally, improving radio network performance, and ensuring highest level of customer experience by improving quality and reducing the total cost of ownership (TCO). The present invention not only leads to quality improvement and TCO reduction but also ensures that required corrective actions are taken instantaneously by always being on communication link with field technicians. The present invention is capable of reducing end to end time taken to conduct the drive test procedures by optimizing the processes including but not limited to closely monitoring activities of one or more drive test technicians who are on field, and reducing the number of redrives. As the number of redrives are reduced, the present invention is responsible for reduction of distance to be covered in drive testing, which also results in fuel optimization. Thus, the present invention shares its own bit towards carbon footprint reduction goals of telecom industry.

The present invention is configured to integrate field processes and centralized processes holistically apart from providing a wider outlook as well as an integrated, correlated, context sensitive Geo spatial analytics covering wide range of methodologies like over-the-air (OTA) App based data collection, crowdsource data collection and operations support systems (OSS) data with the drive test data.

For the purpose of the present description, expressions ‘drive testing team’ and ‘field team’ are used interchangeably hereinafter. Also, expressions ‘drive testing’ and ‘field testing’ are also used interchangeably hereinafter.

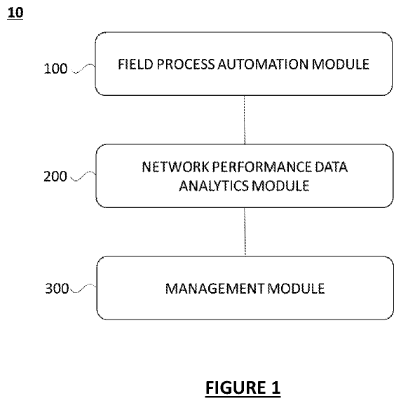

FIG. 1 illustrates a block diagram of a radio network performance optimization system in accordance with a preferred embodiment of the present subject matter. The system according to the present invention includes a plurality of modules or sub-systems. For example, and by no way limiting the scope of the present invention, major modules of the system include a field process automation module 100, a network performance data analytics module 200, and a management module 300.

The field process automation module 100 is configured to automate the field processes in a drive testing procedure. In a preferred embodiment, the field process automation module 100 further comprises but is not limited to a hardware check module 102, a license validation and setup module 104, a route determination module 106, a geofencing module 108, a vendor agnostic module 110 and a data collection module 112.

In a preferred embodiment, the hardware check module 102 is configured to evaluate all the required components and in case any modification is required, the hardware check module 102 is configured to raise an alarm even before the team sets out for the field testing activity. This can be handled at the base location and the team does not lose any time on field, especially with hardware related issues, while performing the field-testing activity. In an embodiment, the license validation and setup module 104 comprises, but is not limited to, a plurality of prebuilt scripts. The license validation and setup module 104 is configured to verify software versions of all handsets and that of the system. This module 104 is configured to perform compatible settings from the central location, thereby ensuring that the data used while performing the data collection activity is approximately 100% correct and complete and there is no delay in performing the data collection activity.

In a preferred embodiment, the route determination module 106 is configured to determine the shortest path or route to the starting point and to provide route MAP automation/centralization. The time taken by a field team to arrive at the starting point from where data collection activity is to start is a critical aspect in a drive testing procedure. The route determination module 106, while assigning task to the field team, is configured to plot their current location and to provide them with an automated route map. This automated route map acts as the shortest path to reach the starting point from current location. The route determination module 106 not only provides shortest path to the field team, but also tracks whether they are following the shortest path or not. This way the central team, which is in constant communication with the field team, can immediately alert the field team and bring them back to the desired route.

In a preferred embodiment, the geofencing module 108 is configured to prevent a drive test team or field team from diverting to an undesired location and from starting collection of data before they should. As soon as the drive test team following shortest path arrives at the starting location, the geofencing module 108 triggers an alarm and the central team unlocks the data collection from the field team. This helps in minimizing junk data collection and significant overheads associated with junk data processing and analyzing.

In order to overcome the challenge of human error prone data collection and non-standardization of same activity from different locations, the vendor agnostic module 110 is provided. In a preferred embodiment, the vendor agnostic module 110 is configured to standardize the field data collection process in a common database. This enables improvement in quality of data collection, and efficiency of processing such data.

The size of the data collected for uploading at the end of each activity varies significantly. With sudden inflow of many large sized files, processing of data starts suffering from low resource related issues and results in severe delays. At times, it also results in failure in importing the files. If logs processing is done locally by the field team, the process again leads to non-standardization and is prone to human induced errors. Moreover, overall manual operations leave a room for data manipulation. In order to optimize collection and standardization of data, the data collection module 112 not only automates the data collection by making a sequence of test cases, which are executed in serial or parallel, but also creates and auto uploads data per unit test case. This ensures that the size of data entering the central server is substantially reduced, backhaul related issues are substantially avoided, and the central server, which processes these log files virtually in real time, is always in a healthy state. This also ensures that end to end data is available for customers within a very small period of time, preferably within 5 to 8 minutes of completion of an activity, and rolling data for the ongoing test is available for view, preferably on a custom built tableau dashboard and/or web portal view with a maximum lag of about 5 to 8 min in an embodiment.

In an embodiment, a user has access to the tableau dashboard via application server Login. This access restricted dashboard allows access to reports as configured under his access rights. In an embodiment, the dashboard presents report automatically with coversheet comprising details of activity, if the activity has passed all criteria, if any criteria has failed, if failed probable reasons and overall ACCEPT/REJECT status. Once such report is available in the tableau dashboard, the user gets an email with link for the specific report. In an embodiment, such report is available to a user within 10 min of completion of field data collection activity. The same tableau dashboard access is granted to the operator, OEM and SI personnel in an embodiment such that all have visibility of report on common platform, thereby removing any guesswork, doubts and allowing activity acceptance to be closed instantly. In case any further activity needs to be done on field as evident from the report, the field team can be informed and same can be concluded instantly with no need for redrives.

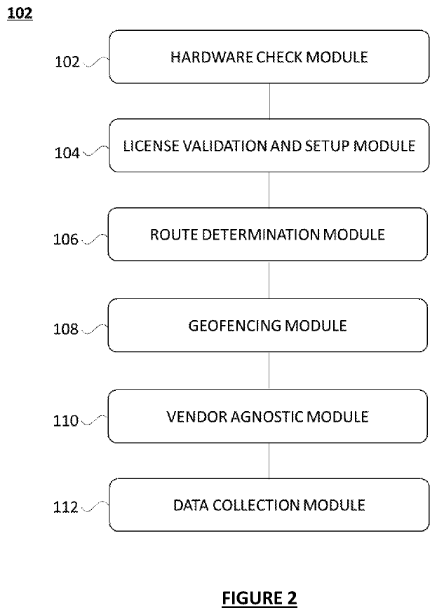

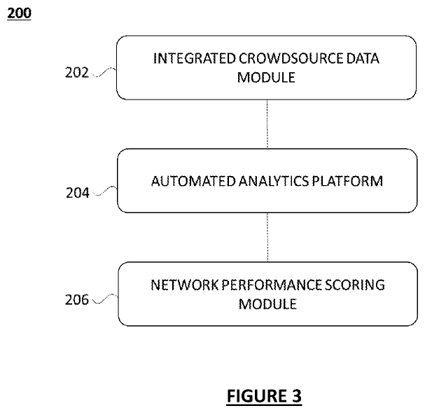

FIG. 2 illustrates a block diagram of the network performance data analytics module 200 in accordance with a preferred embodiment of the present subject matter. In a preferred embodiment, the network performance data analytics module 200 is configured to perform centralized automated data analytics and to minimize the number of drive test engineers per test team required for drive testing procedures, thereby substantially reducing the cost associated with components and man hours in the overall drive test procedure. The network performance data analytics module 200 comprises but is not limited to an integrated crowdsource data module 202, an automated analytics platform 204, and a network performance scoring module 206, as shown in FIG. 3, which depicts a block diagram of the network performance data analytics module 200 in accordance with a preferred embodiment of the present subject matter.

The network performance data analytics module 200 is configured to perform all health checks and other checks as mentioned hereinabove. The network performance data analytics module 200 enables a central Network Operations Center (NOC) Engineer or team of engineers to have a real time view of a drive test screen for ensuring almost 100% accurate data collection. The central NOC engineer is provided with a combined view of the path being taken by all drive test teams on one consolidated screen in an embodiment. In a preferred embodiment, a plurality of alarms is provided, which bigger in case any team violates the shortest path or in case any test case execution encounters any problem on field. The central NOC Engineer is provided with all required tools and facilities to easily monitor and manage multiple teams on ground. In an embodiment the central NOC Engineer is capable of monitoring and managing about 10 teams. However, the number of teams being monitored and managed by the central NOC Engineer may be more or less without departing from the scope of the present invention.

In an embodiment, the network performance data analytics module 200 is also configured to create a view of Key Performance Indicator (KPI) violation alarm with context sensitive drill down by processing short logfiles. This helps the NOC engineer to take an informed decision about changes to be implemented on specific sites, and/or redrive to be done with focused reasoning. In a preferred embodiment, the NOC engineer has at least one easy Graphical user interface (GUI) driven screen to customize test scripts and upload customized scripts on respective drive test technician solution. This ensures that every single drive test activity is full in all respects, has optimum KPI values and significantly increases first time correct ratio of activities done.

As industry trends are changing, it is imperative to have 360° view of network providing not only network performance information, but also customer experience view. In this respect, in a preferred embodiment, the network performance data analytics module 200 comprises an integrated crowdsource data module 202 that Includes highly flexible map-based analytics and integrated Open Source Software (OSS) data sets with on field drive test data. The integrated crowdsource data module 202 is configured to provide real 360° view of Geospatial Intelligence of network performance data with associated customer experience data.

In a preferred embodiment, the network performance data analytics module 200 comprises an automated analytics platform 204. In an embodiment, the automated analytics platform 204 is configured to provide context sensitive layer 3 (L3) message drill down with correlation for addressing all associated problems while saving huge time and improving quality. The automated analytics platform 204 is configured to provide deeper understanding of any KPI violation in an embodiment.

The network performance data analytics module 200 further comprises a network performance scoring module 206 in an embodiment. In a preferred embodiment, the network performance scoring module 206 comprises ETSI 103.559 compliant Network Performance Scoring platform. In a preferred embodiment, the network performance scoring module 206 is configured to compare gold standard Performance with current performance, thereby generating a rank of operators. This module 206 enables operators to fast track their acceptance process of tasks delivered by their vendors. Easy GUI and dashboard driving visibility enables easy checking of every single activity. This ensures that the system 10 has visibility and informed error free decision-making capability, thereby directly impacting customer experience.

Envisaging customer needs to understand the trend of network performance, the present system 10 further comprises a network performance data repository in an embodiment. In a preferred embodiment, the system employs Machine Learning (ML) and Artificial Intelligence (AI) driven approach with Geospatial intelligence driven algorithms to store data in the network performance data repository in an extremely efficient manner, thereby enabling the user to retain data for much longer duration. In a preferred embodiment, a big data architecture is provided that is configured to quickly scan and capture data of interest from huge data repository. The big data architecture also allows building complex custom-built GUI driven queries for visualizing and analysing network performance that suits the needs of hour and deployment as well as operating strategies of every customer. The custom query builder allows a query to be built across dataset from all types of sources, thereby assisting customers to improve network performance and ascertain benefits by directly associating customer experience improvement with improved network performance. Hence, the system 10 according to the present invention is combines forces of network performance improvement initiatives with customer experience improvement initiative.

In an embodiment, the network performance data analytics module, also referred to as the solution and analytics platform in the present embodiment, is built with algorithms that allow 360 degree view of data including but not limited to crowdsource data, field drive test/IBS/Walktest/BM data, Over the Air (OTA) app generated data and Operations Support System (OSS) data with custom defined Bin size up to 10 m×10 m bin individually each type of data, or mix of data with context sensitive link of data from all sources, allowing distance and time based Zoom In/Out capability.

The management module 300, in a preferred embodiment, is configured to provide deep visibility and control over the entire process. In particular, in an embodiment, the management module 300 is configured to perform vendor scoring, team scoring, sites scoring, cluster scoring, drill down from entire network to a specific site for giving great understanding of bottlenecks in network performance improvement. The management module 300 in a preferred embodiment comprises a backhaul map. In a preferred embodiment, the backhaul map comprises fiber backhaul or fiber layout map. In another embodiment, the backhaul map may include microwave. The backhaul map integrated visibility allows operators to take informed decision on investments, thereby resulting in improved return on investment (ROI). In a preferred embodiment, the management module 300 provides details of efficiency improvement trend, savings on gasoline and carbon credit, market area benchmark with respect to cost versus customer experience improvement, network performance improvement, NPS improvement, integrated view of Network performance activity/spend plan versus marketing plan and changing customer demography plan, project initiation to rollout—efficiency trend, trend for effective utilization of resources—CAPEX/OPEX, human resources, solution resources, compliance score for each market area divided into compliance score for market leads and compliance score for vendors.

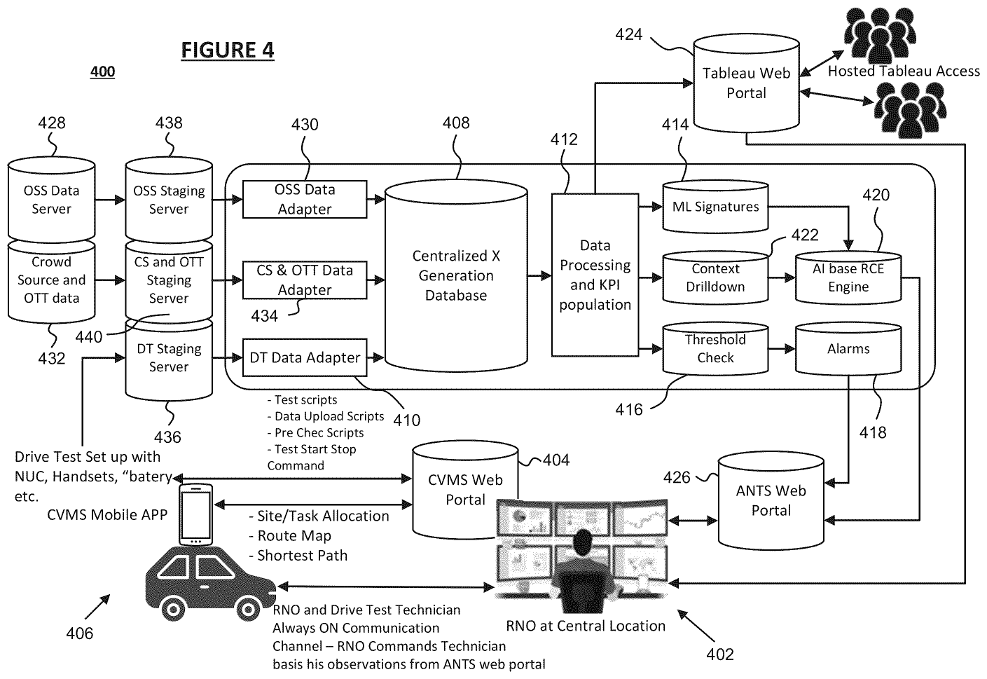

FIG. 4 illustrates an architecture of a radio network performance optimization system 400 in accordance with one embodiment of the present subject matter. The system 400 is configured to integrate field processes with solutions and centralized processes holistically. While doing an holistic integration, the system 400 with a wider outlook provides an integrated, correlated, context sensitive Geo spatial analytics covering wide range of methodologies like OTA App based data collection, crowdsource data collection and OSS Data; all integrated with drive test data. In an embodiment, the system 400 allows users to allocate tasks to teams with definitive test scripts, shortest route to starting point from base location, route map for the activity to be done and expected end time of the test. The system 400 not only provides real time visualization of routes being followed by the field team but is also configured to generate an alarm in case a field team deviates from allocated shortest path. Further, the system is configured to generate geofencing alarm as soon as field team arrives at the starting point in an embodiment. Moreover, occupational health and safety (OHS) compliance of the vehicle and the field team ensures that the vehicle is driven as per OHS compliance requirements of the law of land. Further, working on height needs OHS certification and special OHS gear. In a preferred embodiment, the present system is configured to allow track of all activities and raises an alarm if any OHS violation is observed, in accordance with one embodiment of the present invention.

In a preferred embodiment, major components of the system 400 comprise but not limited to a centralized database set up 402, a centralized web portal 404 and a drive test set up 406. The centralized database set up 402 is provided at a central location and is controlled by a central team. In an embodiment, the central team may comprise one or more than one professional. The central team is in constant communication with the field team that operates the drive test set up 406 in a vehicle. In an embodiment, the central team commands the field team based on the observations received by them through the centralized web portal 404. In an embodiment, the drive test set up 406 comprises at least one NUC, at least one communication device, at least one battery etc. required for field testing. In another preferred embodiment, the drive set up also comprises one or more Android/iOS platforms in the communication device. In a preferred embodiment, the communication device comprises but is not limited to one or more of mobile handsets, tablet computers and the like.

The centralized database set up 402 comprises a database which contains Information regarding the kind of testing required by the field team at a specific location. Based on this information, the centralized database set up 402 automatically generates desired scripts and sends these scripts to the drive test set up 406 through the centralized web portal 404. In an embodiment, the scripts comprise but not limited to test scripts, data upload scripts, pre-check scripts, test start/stop command etc.

In an embodiment, the system comprises vendor/solution agnostic test scripts for different types of test requirements such as voice calls testing which ranges from traditional short call, long call to typical MOS measurement cases, more advanced CFSB and VoLTE test cases and Data Test scripts range from typical FTP, HTTP, ping test to video streaming test, and customized application tests. These scripts being result and test case oriented, are vendor agnostic. With scripted testing, the system ensures that test set up is standardized, test case sequence is standardized, there is no need for human intelligence to define required type of test of field or no need to spend additional time on field for setting up solution for required tests. Further, these scripts also take care of variety of test scenarios and are optimized for the same. A repository of such scripts is kept at CVMS in an embodiment. In another embodiment, appropriate test scripts are allocated to field team as per testing activity required to be performed.

In an embodiment, the test scripts provide maximum samples of collected drive test data. Further, log files are uploaded in predefined duration which ensures seamless availability of data for instant processing. Furthermore, Log file size is defined by time, by File Size or completion of activity whichever is earlier in an embodiment. For example, if a user programs log file to be swapped at every 10 seconds, with a max file size of 10 MB, the script ensures creation and upload of log file to the centralized server at every 10 seconds. In case log file size reaches a limit of 10 MB before completion of 10 seconds, then log file size limitation takes precedence and file is uploaded to central server. In case test script is executed completely and nature of test case does not generate a log file of over 10 MB size or does not take 10 seconds to complete, then log file is uploaded on completion of the test case. Hence, the scripts are intelligent to ensure that log files are always generated with a maximum file size of pre-defined file size. This ensures standardization of test activities across all vendors/all drive test campaigns, availability of required KPI's/parameters for every single drive test campaign and near real-time visibility of data. Further, this enables data upload completion along with the activity completion. Therefore, there is no wastage of time in data upload. At no juncture, data is lost due to file size being too heavy to be uploaded. Furthermore, processing of infrastructure can be planned well with known load and is always in a healthy state. Moreover, there are no queuing related delays in report generation and the reports are delivered faster with improved activity efficiency.

In a preferred embodiment, the centralized database set up 402 automatically allocates site or task to a drive testing team or field team having a drive test set up 406. In another embodiment, a route map and shortest path is also conveyed by the centralized database set up 402 to the drive testing team or field team having a drive test set up 406.

Once the drive testing is complete, data received from the drive test set up 406 is sent to the centralized database 408 after converting said data into a desired common format suitable for processing in the centralized database 408. In an embodiment, one or more data adapters 410 comprising software terminals are provided to convert the data received from the drive test set up 406 into the desired format. Once the data is saved in the centralized database 408 in the desired format, a data processing and KPI population module 412 performs the data processing. A Machine Learning module 414 is configured to perform violations in the system. The central team is configured to monitor a plurality of drive testing teams. A threshold check module 416 is provided for performing real-time monitoring of all parameters and details of each drive test. As the data is collected in each drive test and processing of collected data is initiated, the threshold check module 416 checks all parameters collected in each drive test. In case a parameter collected in a drive test does not meet the threshold value, the threshold check module 416 triggers an alarm 418 to the central team for enabling the central team to take a corrective action. The violation in a parameter identified by the threshold check module 416 is analyzed by the Machine Learned module 414 and fed into an AI based root cause analysis (RCA) engine 420. In an embodiment, the RCA engine 420 is configured to identify the root cause of the violation, prompt the possible causes and propose corrective measures to the central team for correcting said violation in the parameter. Meanwhile, a context drilldown module 422 identifies all the other parameters associated with violated parameters that led to such violation in an embodiment. In a preferred embodiment, the context drilldown module 422 displays detailed information about all the associated parameters to the central team in real-time. In an embodiment, the information from the context drilldown module 422 is directly sent to the central team for correction of violation. In another embodiment, the information from the context drilldown module 422 is fed into the RCA engine 420 for further processing before the same is sent to the central team. In yet another embodiment, the information from the context drilldown module 422 is sent directly to the central team as well as to the RCA engine 420. In an embodiment, the central team performs additional tests to confirm the possible cause and corrective measures to be taken to correct the violation. Once the possible causes and corrective measures are identified, the central team communicates with the field team to fix the violation. In an embodiment, it is possible with the present system to identify and analyze possible causes as well as corrective measures in less than 24 hours due to real-time gathering of information and correction of violation, which otherwise used to take few weeks in conventional drive testing processes.

In an embodiment, once the analyzed data is available in the centralized database 408, a 360-degree analytics of the same can be performed. In another embodiment, access of the processed data is given to one or more users or customers through a tableau web portal 424. In yet another embodiment, the users may access the processed data through one or more dashboards and this processed data may be depicted through graphs, charts, text etc. In a preferred embodiment, the system is configured to grant access of the processed data in real time to the users. The information from the RCA engine 420, tableau web portal 424 as well as the alarm information is transmitted to the central team through the centralized web portal 426.

In a preferred embodiment, the OSS data is collected in an OSS data server 428 and fed into the centralized database 408 through an OSS data adapter 430. In another preferred embodiment, the crowd source and over-the-top (OTT) data is collected in a crowd source and OTT data server 432 and is fed into the centralized database 408 through a crowd source and OTT data adapter 434. In yet another embodiment, the system 400 comprises a plurality of staging servers comprising a drive test staging server 436, an OSS staging server 438 and a crowd source and OTT staging server 440 as temporary hosting and staging servers.

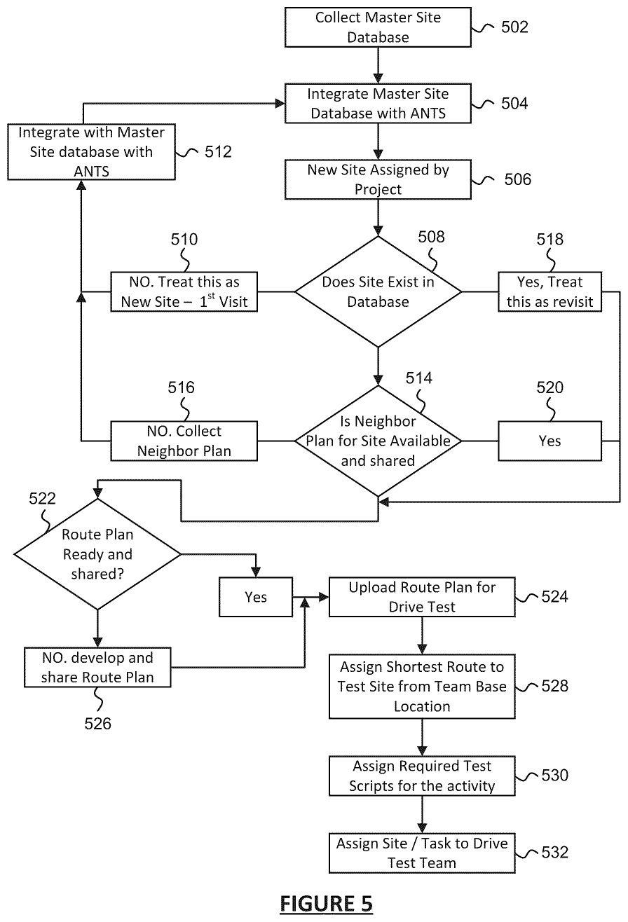

FIG. 5 illustrates a flow chart of a site task allocation process 500 in the radio network performance optimization system in accordance with one embodiment of the present subject matter. The site task allocation process 500 starts with the step 502 of collecting master site data obtained from OSS data server 428. In a preferred embodiment, the master site data comprises network configuration information, such as information about height of antenna, downward tilt applied to the antenna, power at which the antenna operating and so on. This is followed by the step 504 of integrating the collected master site data with data present in the centralized database 408 of the system. In this step, the master site data is converted into the common format that is suitable for processing in the centralized database 408 in an embodiment. In another embodiment, only required information from the master site data is collected in the centralized database 408 and other irrelevant data is rejected in this step. Once the required data in suitable format is saved in the centralized database 408, the system checks 506 if there is a new site or new tower assigned by the project team. This is followed by comparing 508 information about the probable new site with data available in the centralized database 408. If information of the probable new site is not available in the centralized database 408, the system treats the probable new site as a new site in step 510. Thereafter, the system integrates 512 information of the probable new site with data available in the centralized database 408 in a similar manner as done in step 504. The data integrated by the system in the centralized database 408 comprises but not limited to location and specifications about new tower. The system then checks 514 if the neighbour plan for the site is available and shared. In an embodiment, the neighbouring plan includes but is not limited to information about neighbouring sites or neighbouring towers as well as other surrounding information such as driving and network conditions which may impacting collection of data etc. If the neighbour plan is not available in the centralized database 408 and shared, the system collects 516 the neighbour plan and integrates 512 information about said neighbour plan with data available in the centralized database 408 in a similar manner as done in step 504.

On the other hand, if upon comparison in step 508, it is determined that information of the probable new site exist in the centralized database 408, the system treats 518 this information as revisit of existing site sends this information for further processing. Similarly, if upon comparison in step 514, the system determines 520 that the neighbour plan is available in the centralized database 408 and shared, the system sends this information for further processing.

In step 522, the system checks if the route plan for collecting data is ready and shared. If route plan is already shared, the system uploads 524 the route plan for drive testing. If, on the other hand, the route plan is not ready, the system develops 526 a new route plan for sharing with the field team and then uploads 524 the same for drive testing in an embodiment. In another embodiment, the route plan is developed 526 and uploaded 524 in for drive testing by the central team. The system then assigns 528 the shortest route for a field team from their current or base location to the test site and shares this shortest route to the field team. The system also assigns 530 the required test scripts to the field team for performing the drive testing. Thereafter, the system assigns the site and task to the drive test team for initiating the drive testing procedure.

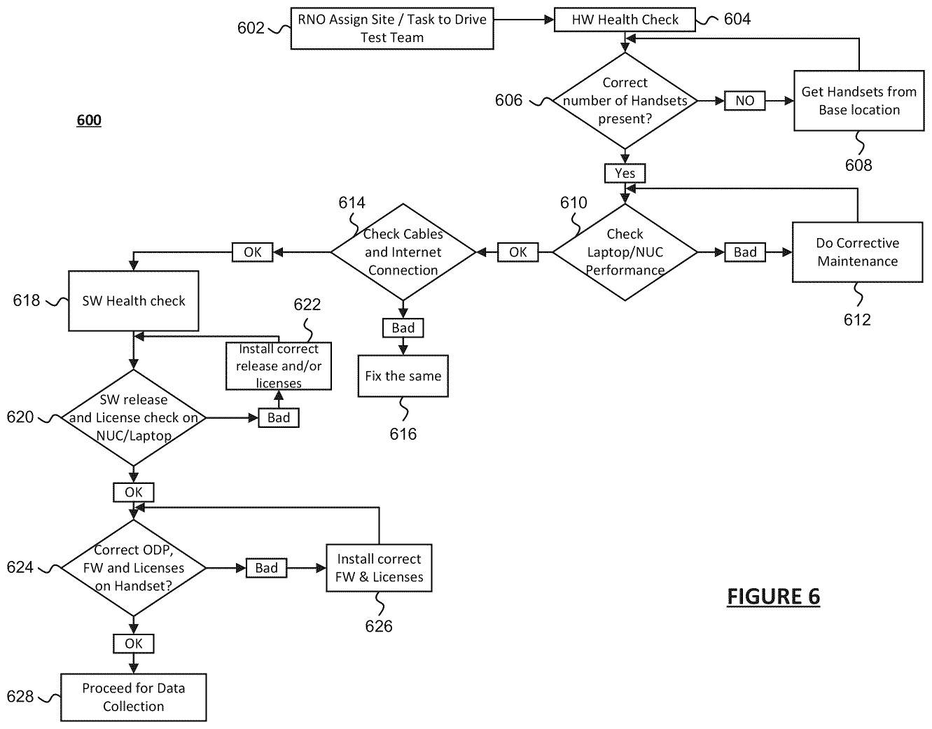

Before a drive testing process is initiated, the system performs a plurality of pre-checks in order to ensure smooth data collection during the drive testing. FIG. 6 illustrates a flow chart depicting pre-checks 600 to be performed before collection of data in the radio network performance optimization system in accordance with one embodiment of the present subject matter. Once the site and task are assigned 602 by the central team to the drive test team, a hardware check is first performed 604 in an embodiment. The system checks 606 if the correct number of handsets are present with the drive test team. If it is found that adequate number of handsets are not available, the system prompts the central team to obtain 608 handsets from base location. Once adequate handsets are obtained, the system checks 610 performance of electronic devices, such as laptops, NUC etc. If the performance of at least one electronic device is not adequate, the system performs 612 the corrective maintenance at the base location in an embodiment. In another embodiment, the system prompts the central team to perform corrective maintenance of said electronic devices. The system then checks the cable and internet connections in step 614. In case the connections are bad, the system either fixes the same or prompts the central team to fix them in step 616. This completes the hardware health check.

In an embodiment, hardware health check comprises power ON checks at the base locations, checking hard Disk, RAM, BIOS of computing system at power ON for performance, monitoring storage utilization, CPU utilization, RAM utilization, battery conditions at regular intervals for ensuring healthy performance of the system throughout drive test activity, etc. The system performs check to confirm healthy inter connectivity of all required components and checks if required number of test handsets are connected to the test system. Number of test handsets can be derived from activity that is required to be performed at test Location in an embodiment. Hardware health checkup ensures 100% uptime of test system while data collection team is on field. This ensures data collection accuracy as any inaccuracy in collected data due to unhealthy test system is addressed by hardware health checkup. While improving data collection accuracy, hardware health checkup with 100% uptime of test system helps avoid any expensive time delays in task completion on account of failed system. It also saves cost by not having to invest into additional expensive test systems and shield test system from wear and tear.

Once the hardware health check is complete, the system initiates 618 the software health check. The system checks for any new software release and licenses in the electronic devices in step 620. It is important to ensure that all devices have compatible software installed and have healthy network connectivity. It is also important to ensure that all required software licenses are deployed and enabled in order to avoid any delays on account of non-available software features in the test system. Purchasing software license or delivering software license is a time-consuming task and at times can lead to weeks of delays with redrives to be done. With changing project requirements, change in field teams, swap of field teams and host of other reasons, drive test solution composition keeps changing frequently. It is observed that field teams at time spends days together to just get all required components communicate healthily with each other. In case any gaps in required licenses, it leads to additional delays.

In case any update is required in step 620, the system installs the correct software release and/or licenses in step 622. Thereafter, the system checks 624 if correct open source, firmware and licenses are available in the handsets. In case these licenses are not available, the system installs correct firmware and licenses in the handsets in step 626.

In an embodiment, the system comprises one or more inbuilt processes which check software version of main application, software version of application compatibility with software version of processing infrastructure, software version and required ODM version deployed on test devices for compatibility etc. Further, the system tests handset communication with centralized database in an embodiment. In another embodiment, the system checks for test script readiness and correctness, data upload script correctness, connectivity with the centralized database and any unwanted software application deployment.

Such comprehensive software check process ensures 100% utilization of each and every drive test field resource, deliver project much before the end date, improve accuracy of data collection at the same time efficiency of data collection. It also enables in avoiding any lapse in data not being presented to back end data server due to network connectivity issues. All these helps improve data collection accuracy, gain best utilization of drive test resources, reduce drive test cost and gain unique drive test benefits which were otherwise overlooked due to inherent inefficiencies and process delays in conventional systems. Once the software check is complete, the system grants 628 the permission to the field team for data collection.

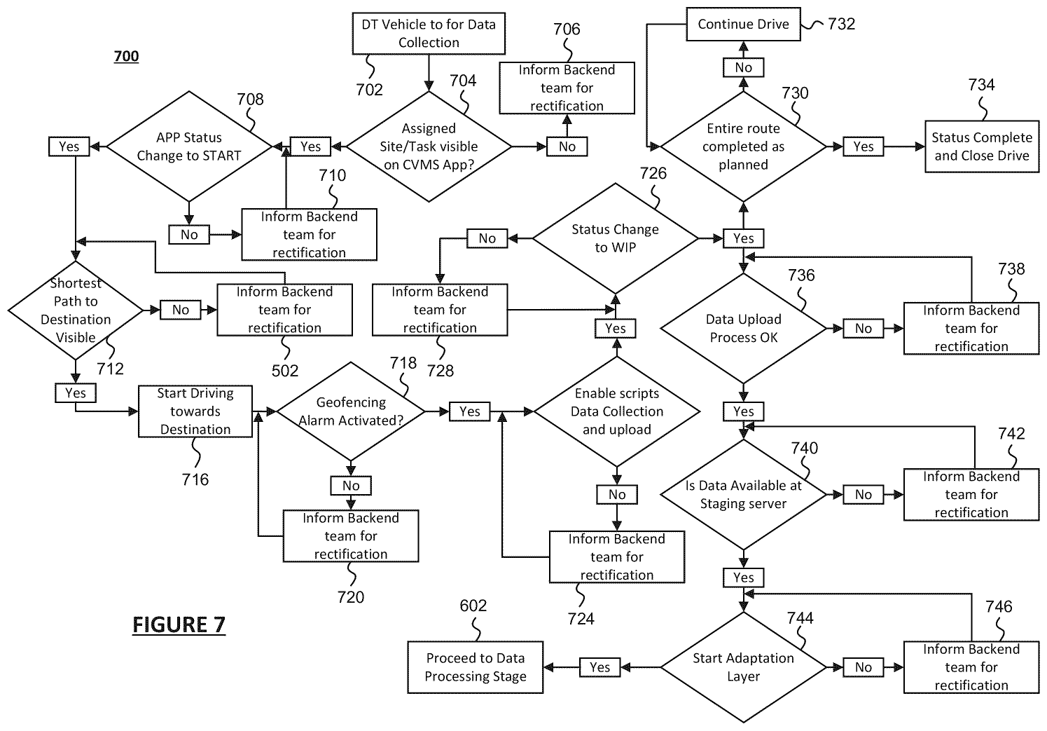

FIG. 7 illustrates a flow chart depicting data collection process 700 in the radio network performance optimization system in accordance with one embodiment of the present subject matter. The data collection process 700 commences by step 702 in which the drive test vehicle is driven for data collection. The system then checks 704 if the assigned site and task are visible to the field team in the drive test vehicle. In a preferred embodiment, the assigned site and task are available to the field in a centralized vendor management system platform available in the mobile handsets of the field team. In another preferred embodiment, the screens of the mobile handsets of the field team are replicated to the central team at the central location. In case this information is not visible to the field team, the system informs 706 the central team for rectification. The system then checks 708 if the status of the centralized vendor management system platform has updated to‘START’ in step 706. If the status is not updated, the system informs 710 the central team for rectification. Thereafter, the system checks 712 if the shortest path to the destination is visible to the field team. If not, the system informs 714 the central team for rectification. Once the shortest path is visible on the centralized vendor management system platform, the field team starts driving 716 towards the destination. At all stages, the central team keeps a track on the vehicle driven by the field team in a preferred embodiment. If there is a deviation of the drive testing vehicle from the prescribed shortest path, the system identifies the same and prompts the central team to communicate with the field team for taking corrective measures. Just before the drive testing vehicle is about to approach its site location, the system activates 718 the geofencing alarm. In case the geofencing alarm is not activated at the desired moment, the system prompts 720 the central team for rectification. After the geofencing alarm is activated 718 nearer to the site location, the central team grants permission to the field team to collect data. In this regard, the scripts for data collections are enabled and uploaded into the system in step 722. In case the scripts are not enabled and uploaded in time, the system prompts 724 the central team for rectification. Once the system starts collecting data from the site, the status of the system changes to ‘Work in Progress’ in step 726. In case the status is not changed in this step, the system prompts 728 the central team for rectification. Thereafter, the system checks 730 if the entire route is complete as planned. If the route is not completed, the system prompts 732 to continue the drive and once the route is complete, the status is changed to ‘Complete’ and the drive test is closed in step 734. Simultaneously when the drive testing vehicle is en route, the system checks 736 if the data uploaded process is being performed or not. If the data is not getting uploaded, the system prompts 738 the central team for rectification. Once the data is uploaded, the system checks 740 if the data is available at the staging server. In case the data is not available, the system prompts 742 the central team for rectification. As soon as the data is available in the staging server, the system initiates 744 the adaption layer. In an embodiment, the adaption layer comprises finding a new data en route the vehicle. In case this step is not initiated, the system prompts 746 the central team for rectification. Thereafter, the system sends the data for processing in step 748.

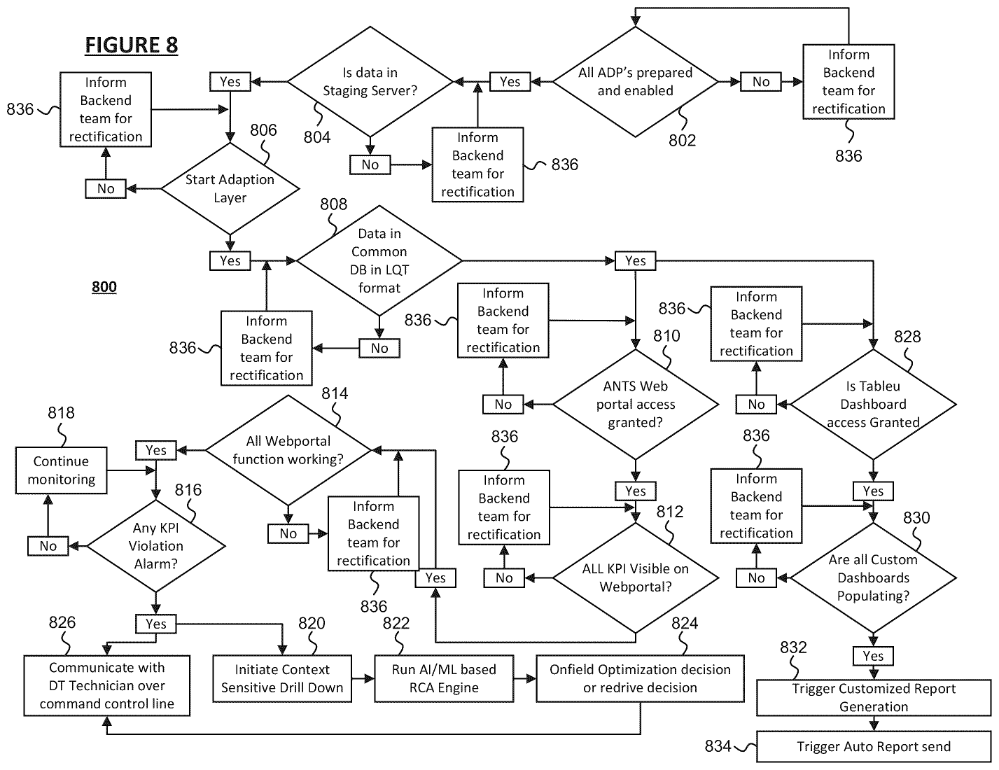

FIG. 8 illustrates a flow chart depicting data processing 800 in the radio network performance optimization system in accordance with one embodiment of the present subject matter. The data processing 800 initiates by checking if automated data processing (ADP's) or data adapters are prepared and enabled 802. Then the system checks 804 if the data is available in the staging server or not. If the data is available in the staging server, the system starts the adaption layer in step 806. Thereafter, the available data is converted 808 in the common database format After the data is converted in the common database format, the system checks 810 if web portal access is granted to the user and subsequently checks 812 if all KPIs are visible on the web portal. The system then performs a check 814 if all web portal functions are working and simultaneously identifies 816 if any KPI violation alarm is triggered. In case the KPI violation alarm is not triggered, the system continues to monitor the same in step 818. However, if the KPI violation alarm is triggered, the system initiates the context sensitive drill down in step 820, runs the AI/ML based RCA engine in step 822, takes the decision in respect of on-field optimization or redrive in step 824 and communicates with the drive testing team or field team in step 826.

In an embodiment, simultaneously to the step 810, the system checks if tableau database access is granted to the customer in step 828 immediately after the data is converted in the common format. The system then checks 830 if the custom dashboard available to the customer is populated and then generates 832 reports customized as per the requirements of customers. Finally, the system automatically sends 834 the report generated in step 832 to customers through email or any other communication means.

In an embodiment, the system prompts 836 the central team for performing rectification in case the steps described in 802, 804, 806, 808, 810, 812, 814, 828 and 830 are not performed, as shown in FIG. 8.

In an embodiment, data processing and analytics is performed in an intelligent centralized processing platform which Imports all uploaded logs automatically. The data upload test scripts automatically upload log files to centralized database or central server as per configurable time/file size parameter. All imported logs are processed and stored in the unified common database. In an embodiment, users/central team members log into the application server which comprises a visualization portal. The visualization portal is a web portal on which the user gets near real-time visualization of KPI's as collected from field data collection tool. The Web portal also allows integrated visualization of KPI's as collected from crowdsource Data, OTA Data, as well as field data collection data in an embodiment. The context sensitive drill down feature allows an integrated context sensitive analysis of network performance and arrive at a logical conclusion. A user/central team member, then can make an informed on-field optimization decision. The portal allows the user/central team member to modify test scripts, direct on-field data collection team to do a redrive on smaller area, do specific test as per new script for further detailed analysis etc. As part of larger network MS with integrated customer complaints, crowd source data, OTA data, OSS data and field drive test data, the system can identify areas suffering with poor customer experience by combination of crowdsource and OTA data and match same with OSS Data for those areas. If both OSS data and crowdsource/OTA data confirm poor performance, the user can decide on priority for detailed troubleshooting drive to be done on field to address identified problem. If OSS data does not show any problem, but crowdsource and OTA data show poor KPI, the system can check for VIP performance impact and accordingly assign priority, required test scripts to address problem. Further, if OSS data does not show problem and OTA data does not show problem for outdoor subscribers but crowdsource and OTA for indoor/stationary subscribers showing KPI degradation, this can lead user to decide on IBS related test and can set priority as well as testing accordingly. Furthermore, integrated analysis also helps the user drill down information in different dimensions and analyze results for RCA. Context Sensitive L3 drill down of the present system helps in identifying intrinsic issues down to protocol level and recommend on soft parameter optimization, reconfiguration of resources etc. This leads to improved customer experience, improved spectral efficiency and maximize bit/Hz without additional investment in network expansion. The machine learning platform learns from problems, different set of KPI combinations leading to problems, parameter settings in configuration database and variety of other pointers and helps to provide automatic RCA with recommendations. The Artificial Intelligence platform allows predictive intelligence. A 360-degree view of Network performance with AI based predictive information and ML based RCA with recommendations leads to problem resolution before the same appears in the network.

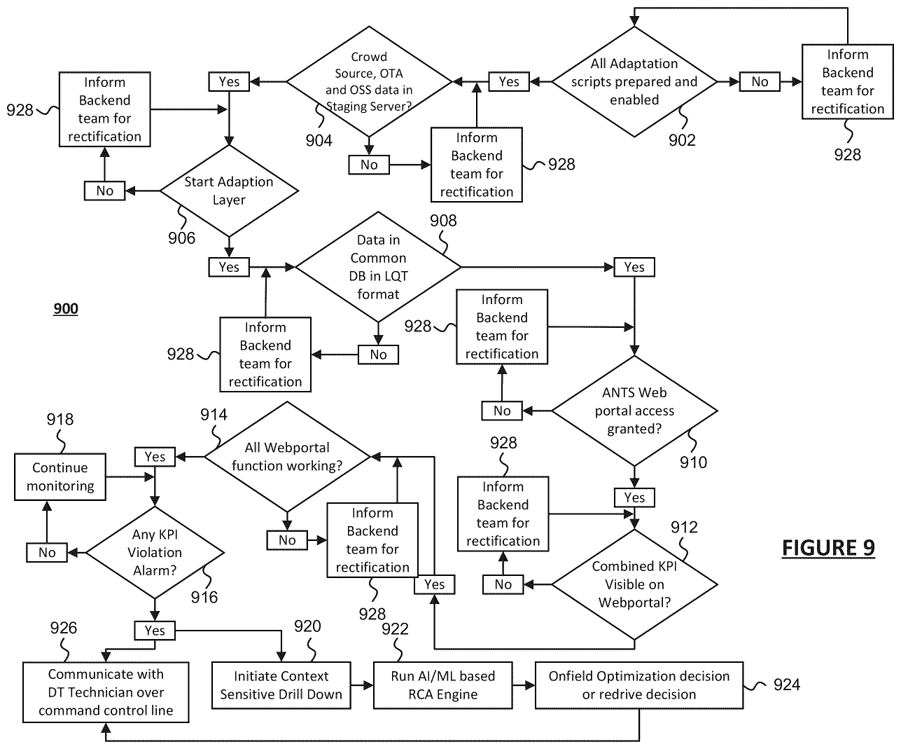

FIG. 9 illustrates a flow chart depicting a 360-degree analysis 900 of the radio network performance optimization system in accordance with one embodiment of the present subject matter. According to one embodiment, the 360-degree analysis 900 is performed simultaneously to data processing 800. However, in another embodiment, the 360-degree analysis 900 may be performed separately from data processing 800. The 360-degree analysis 900 commences with the step 902 in which the system checks if all adaptation scripts are prepared and enabled. The system then checks 904 if crowdsource data, OTA data and OSS data are available in the staging server. Thereafter, the system starts 906 adaptation layer and converts 908 data in common format. Once the data is converted in the common format, the system checks 910 if access to the web portal is granted to the user and checks 912 if the combined KPI is visible on the web portal. Thereafter, the system checks 914 if all web portal functions are working and simultaneously identifies 916 if any KPI violation alarm is triggered. In case the KPI violation alarm is not triggered, the system continues to monitor the same in step 918. However, if the KPI violation alarm is triggered, the system initiates the context sensitive drill down in step 920, runs the AI/ML based RCA engine in step 922, takes the decision in respect of on-field optimization or redrive in step 924 and communicates with the drive testing team or field team in step 926. In an embodiment, the system prompts 928 the central team for performing rectification in case the steps described in 902 to 914 are not performed, as shown in FIG. 9.

Therefore, the system provides a common database architecture which is futuristic, hyper scalable and handle multi-vendor as well as multi source data. Building adaption layers to ensure all vendor data coming from different file formats are converted to a common database format and data storage/structure is modified to meet needs and demands of Big Data Analytics as well as AI/ML driven root cause analysis and predictions.

The 360-degree view of network performance is critical for improved customer experience, best utilization of resources and improved spectral efficiency. The unified common database acts as a key building block by importing and converting crowdsource data into predefined architecture of data storage. The OTA app collects network performance data from every single mobile subscriber with this APP Installed on his handset without revealing any confidential information of the subscriber. The unified database stores measurements from OTA app into same data storage architecture. Unified database has capability of importing network performance counters, configuration data and Faults/ALARM data from OSS systems and store the same within the common database data storage.

The above system provides detailed information about Radio Network Performance by combination of RAN performance information from test script driven field data collection campaign complemented by OTA and Crowdsource data. The binned values of KPI's not only report customer experienced KPI value, but also the KPI value as presented by specific detailed field data collection activity. The next generation hyper scalable big data architecture allows quick retrieval of data from data base—On Time, location, or any other dynamics providing crucial Geospatial Analytics Capabilities. As data is gaining prominence, the data lake architecture of the present system allows North and South bound API's to integrate data of the present system with other value added solutions unifying strengths, multiplying benefits and providing much needed support for digitization drive.

As can be seen from above, the present invention provides 100% automation and process standardization in drive testing procedures and has multi technology drive. The invention is configured to be fully scalable—2G, 3G, 4G, 5G, SSV, Cluster, IBS and BM Drives. By reducing the manual Intervention by humans, the system according to the present invention comprises a fully autonomous drive. By employing the system and method according to the present invention, full automation in respect of field processes and field data collection can be achieved. Moreover, it is possible to have scripted data test and scripted log upload because of the present invention. The present invention provides instant data visibility and enables the user to take highly accurate and instant on-field decisions. The invention enables end to end report generation within a brief period, preferably within 5 minutes of completion of drive test activity in an embodiment. Since the entire process is automated and no human intervention is required, the chances of data tampering are substantially less. With map, table, graph, KPI Exception analysis and context sensitive L3 drill down, the present invention provides near real time RCA and recommendations. Dashboard based report visualization, KPI Exception report, ETSI Scoring for activity leads to instant acceptance of the processes. Further, the present invention ensures that no junk data is collected and processed. The invention enables the user to take informed redrive decision, thereby reducing number of redrives by over 60%. Reduced drive requirement, controlled movement using shortest path and other remote management features ensure significantly less hours of driving on field, thereby resulting in not only cost savings but also improved carbon credits. Therefore, the present invention ensures that time efficiency is significantly improved as field team is technologically supported to arrive at starting point by using shortest path. The invention also ensures improved accuracy of data collection with defined route map, defined test cases and geofencing. Moreover, autonomous drive assists the society at large even in pandemic situations, such as COVID-19 situation.

While the preferred embodiments of the present invention have been described hereinabove, it should be understood that various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

1. A radio network performance optimization system comprising:
a field process automation module configured to automate field processes in a drive testing procedure;
a network performance data analytics module configured to perform centralized automated analytics on the data retrieved from the field process automation module; and
a management module configured to provide manage the field process automation module and the network performance data analytics module.

2. The system as claimed in claim 1, wherein the field process automation module further comprises a hardware check module, a license validation and setup module, a route determination module, a geofencing module, a vendor agnostic module and a data collection module.

3. The system as claimed in claim 2, wherein the hardware check module is configured to evaluate all required components and raise an alarm even before a field team sets out for the activity in case any modification is required.

4. The system as claimed in claim 2, wherein the license validation and setup module comprises a plurality of prebuilt scripts and is configured to check software versions, and to ensure that compatible settings are performed from central location.

5. The system as claimed in claim 2, wherein the route determination module is configured to determine the shortest path or route to the starting point for drive testing and provides route MAP automation/centralization.

6. The system as claimed in claim 2, wherein the geofencing module is configured to prevent the drive test team from diverting to an undesired location and starting to collect data before they should.

7. The system as claimed in claim 2, wherein the vendor agnostic module is configured to standardize the field data collection process in a common database.

8. The system as claimed in claim 2, wherein the data collection module is configured to automate the data collection by making a sequence of test cases, as well as to create and auto upload data per unit test case.

9. The system as claimed in claim 1, wherein the network performance data analytics module comprises an integrated crowdsource data module, an automated analytics platform, and a network performance scoring module.

10. The system as claimed in claim 9, wherein the integrated crowdsource data module is configured to provide real 360 degrees view of Geospatial Intelligence of network performance data with associated customer experience data.

11. The system as claimed in claim 9, wherein the automated analytics platform is configured to provide context sensitive layer 3 (L3) message drill down with correlation for addressing the associated problems.

12. The system as claimed in claim 9, wherein the network performance scoring module is configured to compare gold standard performance with current performance, thereby generating a rank of operators.

13. The system as claimed in claim 1 further comprises a network performance data repository to understand the trend of network performance.

14. The system as claimed in claim 1 employs Machine Learning (ML) and Artificial Intelligence (AI) driven approach with Geospatial intelligence driven algorithms to store data in the network performance data repository.

15. The system as claimed in claim 1 further comprises a big data architecture that is configured to quickly scan and capture data of interest.

16. A radio network performance optimization method comprising:
automating field processes in a drive testing procedure;
performing centralized automated analytics on the data retrieved from the automated field processes; and
managing the field process automation module and the network performance data analytics module.
